(19) United States
(12) Patent Application Publication
(10) Pub. No.: US 2012/0212177 A1
(43) Pub. Date: Aug. 23, 2012

(54) ELECTRONIC DEVICE BACK-UP CHARGER

(75) Inventors: Anthony Peacock, Mount Pleasant (AU); Edward Joseph Khoury, Bateman (AU)

(73) Assignee: Anthony PEACOCK, Mount Pleasant, Western Australia (AU)

(21) Appl. No.: 13/504,050

(22) PCT Filed: Oct. 28, 2010
(86) PCT No.: PCT/AU2010/001443

§ 371 Date: Apr. 25, 2012

(30) Foreign Application Priority Data
Oct. 29, 2009 (AU) 2009905300

(51) Int. Cl. H02J 7/00

(52) U.S. Cl. 320/107

(57) ABSTRACT

An electronic device back-up charger 70 comprises a housing 72 provided with a pivoting head portion 74 having an electrical connector 76 mounted thereon for connecting the charger 70 to a electronic device, as well as a battery 78 provided within the housing 72. The battery 78 is electrically coupled to the connector 76 wherein, in use, the connector 76 can be pivoted to the desired angle and connected to a electronic device for temporarily recharging the phone from the battery 78.

### FIELD OF THE INVENTION

The present invention relates to an electronic device back-up charger that can be used for recharging an electronic device, such as a mobile phone, with a low battery charge when there is no access to a power outlet for recharging the device.

Background to the Invention

Mobile or cellular phones have now become standard items for virtually everyone to carry with them wherever they go. The current generation of mobile phones has many advanced features, including internet access, email facilities and all of the features of a personal organiser (PDA). Many people have therefore become very dependent on their mobile phone, not just for personal communication but for their business and work. For such people it is critical that a mobile phone remain charged throughout the day so that its full capabilities can be utilized. However, inevitably occasions arise in which the phone has insufficient charge to last the full day. This could occur, for example, where a number of lengthy calls have been conducted, or when the user has forgotten to recharge the phone the previous night. If the user is travelling, or otherwise has no access to an electrical power outlet, it may not be possible to recharge the phone. This can be very inconvenient.

The present invention was developed with a view to providing an electronic device back-up charger that can be easily carried to recharge the phone in the event of a low battery charge. It will be evident that the device can be used for recharging many other kinds of electronic devices such as PDAs, small digital cameras, etc.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided an electronic device back-up charger comprising:

a housing provided with a pivoting head portion having an electrical connector mounted thereon for connecting the charger to an electronic device; and,

a battery provided inside the housing, the battery being electrically coupled to the connector wherein, in use, the connector can be pivoted to the desired angle and connected to a electronic device for temporarily recharging the phone from the battery.

Advantageously the head portion can be pivoted so that the connector is concealed within the housing. In a preferred embodiment the housing includes an elongate cylindrical portion with the head portion provided at the top end of the cylindrical portion. Preferably the head portion comprises a pivot wheel pivotally mounted on a pivot boss, and the electrical connector is a male connector extending radially outwards from, the pivot wheel. Preferably the electrical connector is a micro-USB connector. Alternatively the electrical connector may be a commercial phone charger connector such as a Nokia connector.

Preferably the pivot wheel is pivotally mounted between first and second head mounting portions of the housing. Preferably the pivot wheel is provided with a flexible electrical coupling between the connector and the battery. Advantageously the pivot wheel is provided with first and second annular electrical ribbon conductors on its respective side faces. Preferably first and second elongate electrical ribbon conductors are provided within the housing for electrically coupling the battery to the first and second annular ribbon conductors respectively on the pivot wheel. Preferably the first elongate ribbon conductor extends up through the first head mounting portion to make sliding electrical contact with the first annular ribbon conductor. Preferably the second elongate ribbon conductor extends up through the second head mounting portion to make sliding electrical contact with the second annular ribbon conductor.

Preferably the battery is a rechargeable battery and the housing is provided with a female electrical connector for connecting the battery to an external charger. Preferably the female connector may be used to recharge the battery using mains power.

Advantageously the electronic device back-up charger is sufficiently small to be carried on a key-ring. Preferably an external carry ring is provided at the base of the housing so that it can be carried on a key-ring or lanyard. Typically the housing of the electronic device back-up charger is between about 2.5 cm and 10.0 cm in length. More typically the housing of the electronic device back-up charger is between about 4.0 cm and 7.0 cm in length.

The present invention further provides a mobile phone back-up charger comprising:

a housing provided with a pivoting head portion having an electrical connector mounted thereon for connecting the charger to a mobile phone; and,

a battery provided inside the housing, the battery being electrically coupled to the connector wherein, in use, the connector can be pivoted to the desired angle and connected to a mobile phone for temporarily recharging the phone from the battery.

Preferably the head portion can be pivoted so that the connector , is concealed within the housing. Preferably the housing includes an elongate cylindrical portion with the head portion provided at the top end of the cylindrical portion.

Preferably the head portion comprises a pivot wheel pivotally mounted on a pivot boss, and the electrical connector is a male connector extending radially outwards from the pivot wheel.

Typically the electrical connector is a micro-USB connector. Alternatively the electrical connector may be a commercial phone charger connector.

The pivot wheel is preferably pivotally mounted between first and second head mounting portions of the housing. The pivot wheel may be provided with a flexible electrical coupling between the connector and the battery. Preferably the pivot wheel is provided with first and second annular electrical ribbon conductors on its respective side faces.

Preferably first and second elongate electrical ribbon conductors are provided within the housing for electrically coupling the battery to the first and second annular ribbon conductors respectively on the pivot Wheel.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of preferred embodiments of an electronic device back-up charger, given by way of example only, with reference to the accompanying drawings, in which:

FIGS. 1 (a) to (f) are a series of top perspective views of a first embodiment of the electronic device back-up charger according to the invention, showing the various positions of an electrical connector for connecting the charger to an electronic device;

FIG. 2 is an exploded top perspective view of the electronic device back-up charger of FIG. 1;

FIG. 3 is an enlarged top perspective view of the electronic device back-up charger of FIG. 1 showing how the pivot wheel is connected to the housing;

FIG. 4 (a) is a top plan view of the electronic device back-up charger of FIG. 1;

FIG. 4 (b) is a section view through the line A-A in FIG. 4(a);

FIG. 5 (a) is a side elevation of the electronic device back-up charger of FIG. 1;

FIG. 5 (b) is a section view through the line B-B in FIG. 5 (a);

FIGS. 6 (a) to (e) are a series of top perspective views of a second embodiment of the electronic device back-up charger according to the invention, showing the various positions of an electrical connector for connecting the charger to an electronic device;

FIG. 7 is an exploded top perspective view of the electronic device back-up charger of FIG. 6;

FIG. 8 is an enlarged top perspective view of the electronic device back-up charger of FIG. 6 showing how the pivot wheel is connected to the housing;

FIG. 9 is a section view through the electronic device back-up charger of FIG. 6 (b) or (d);

FIG. 10 shows the electronic device back-up charger of FIG. 6 with a head portion unscrewed from a cylindrical portion housing a battery;

FIG. 11 (a) is a top perspective view of the embodiment of FIG. 6 showing how various adapters (b)-(f) may be attached to the head portion of the back-up charger;

FIG. 12 is a bottom perspective view of the embodiment of FIG. 6 showing how a multi-head adapter may be attached to the bottom end of the back-up charger; and

FIG. 13 (a) is a bottom perspective view of the embodiment of FIG. 6 showing how various single-head adapters (b)-(f) may be attached to the bottom end of the back-up charger.

### DETAILED DESCRIPTION OF PREFERRED EMBODIMENTS

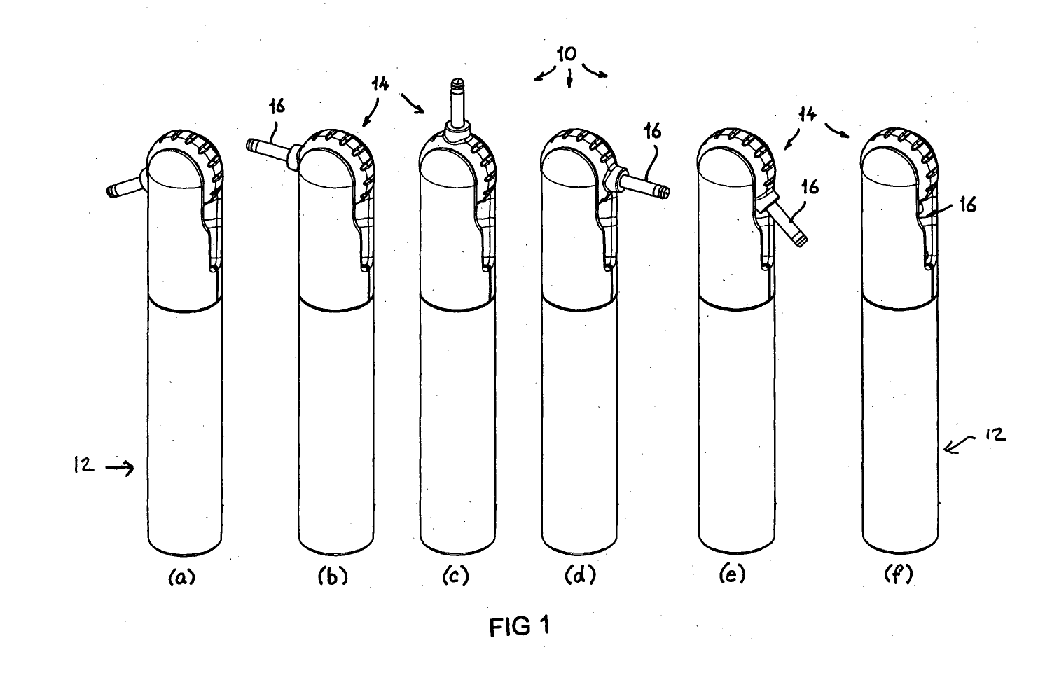

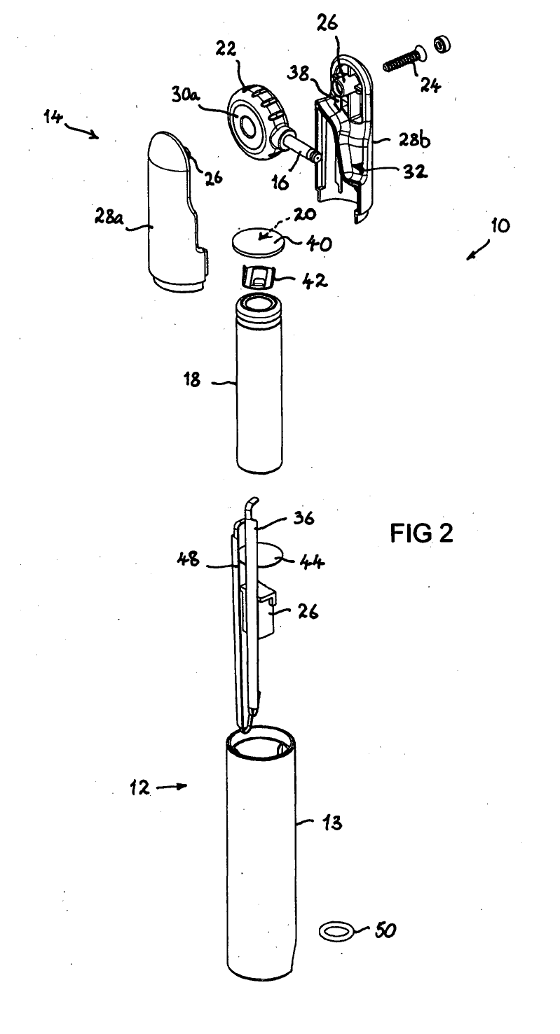

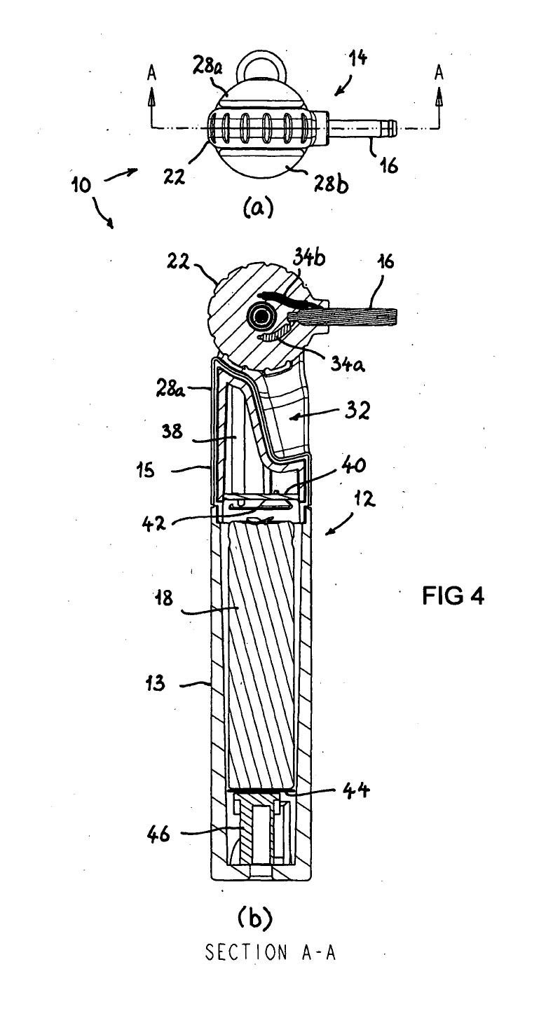

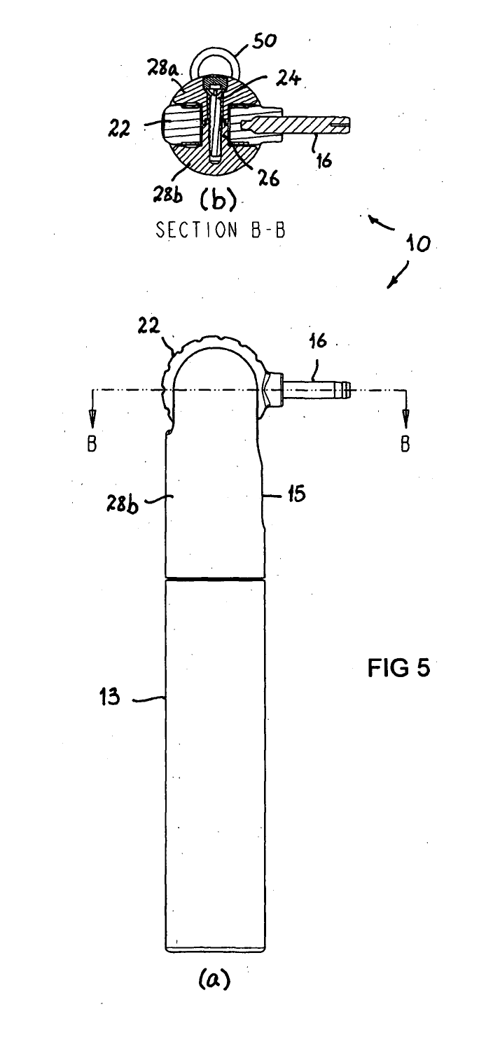

A first embodiment of an electronic device back-up charger 10 in accordance with the invention, as illustrated in FIGS. 1 to 5, comprises a housing 12 provided with a pivoting head portion 14. The head portion 14 has an electrical connector 16 mounted thereon for connecting the charger 10 to a mobile phone (not shown). As can be seen most clearly in FIGS. 2 and 4 (b), a battery 18 is provided inside the housing 12. The battery 18 is electrically coupled to the connector 16. In use, the connector 16 can be pivoted to any desired angle, as shown in FIG. 1, and connected to a mobile phone for temporarily recharging the phone from the battery 18.

The battery 18 may be coupled to the connector 16 via a charging circuit 20.

The charging. circuit 20 may be a conventional battery charging circuit for providing a regulated recharge current and/or voltage from the battery 18 to the electronic device. Alternatively the charging circuit 20 may provide a direct electrical connection between the battery 18 and the connector 16 (and hence to the electronic device). In most cases electronic devices are provided with their own internal charging circuitry and the battery charger is simply an adapter for converting the relatively high voltage AC power from the mains supply to low voltage DC power.

In this embodiment the housing 12 includes an elongate cylindrical body 13 with a head 15 provided at the top end of the cylindrical body 13 on which the pivoting head portion 14 is mounted. Advantageously the head portion 14 can be pivoted so that the connector 16 is concealed within the housing 12, as shown in FIG. 1(f). Preferably the head portion 14 comprises a pivot wheel 22 pivotally mounted on a pivot boss 26, and the electrical connector 16 is a male connector extending radially outwards from the pivot wheel 22. In this embodiment the electrical connector 16 is a standard Nokia mobile phone charger connector. However various adapters (not shown) may be supplied with the electronic device back-up charger 10, for connecting the connector 16 to different electronic device input jacks, for example, a standard Nokia mobile phone charger connector; or the input jack for an iPhone or Blackberry PDA.

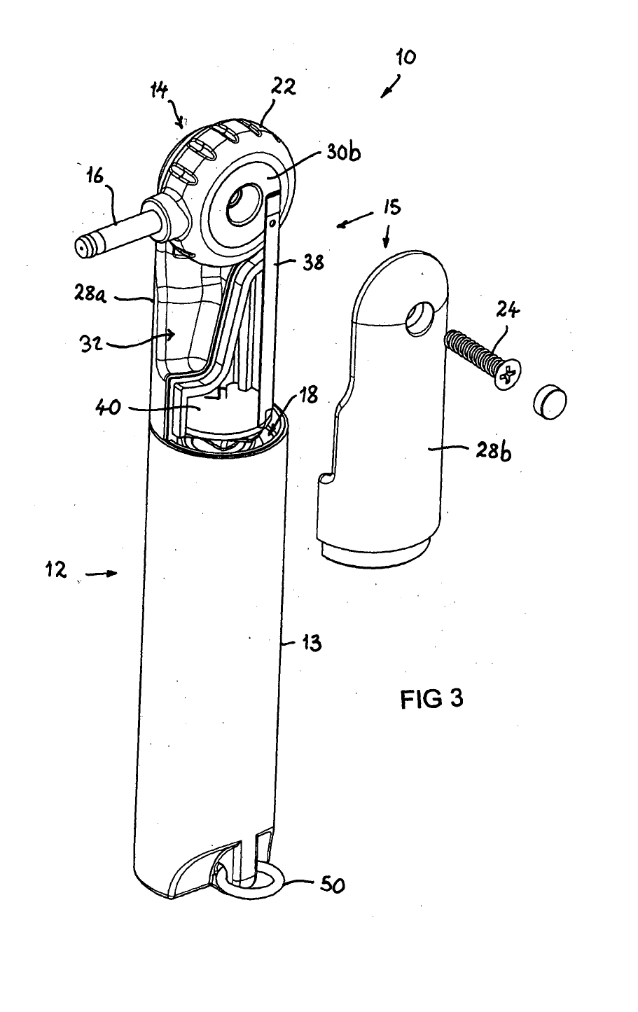

The pivot wheel 22 is pivotally mounted between first and second head mounting portions 28a and 28b of the head 15. The wheel 22 and the first and second head mounting portions 28a and 28b are held together by a screw 24, which passes through the pivot boss 26 for the wheel 22. As can be seen most clearly in FIGS. 2 and 3, the head mounting portions 28 are moulded so as to form a recess 32 when they are joined together. The recess 32 is shaped to receive the connector 16 therein when the pivot wheel 22 is pivoted to its concealed position. The connector 16 is normally pivoted to the concealed position when the back-up charger 10 is not in use. A plurality of indentations is provided around the periphery of the pivot wheel 22 to form a grip surface to facilitate pivoting movement of the pivot wheel with a finger or thumb.

To enable the connector 16 to be pivoted to any desired angle, the pivot wheel 22 is provided with a flexible electrical coupling between the connector 16 and the battery 18. For this purpose the pivot wheel 22 is provided with first and second annular electrical ribbon conductors 30a and 30b on its respective side faces. As can be seen in FIG. 4 (b), the respective terminals of the connector 16 are electrically connected to the respective ribbon conductors 30a and 30b by conductors 34a and 34b respectively. First and second elongate electrical ribbon conductors 36 and 38 are provided within the elongate housing 12 for electrically coupling the battery 18 to the first and second annular ribbon conductors 30a and 30b respectively on the pivot wheel 22.

As can be seen most clearly in FIG. 2, the first elongate ribbon conductor 36 extends from the bottom end of the cylindrical portion 13 up through the first head mounting portion 28a to make sliding, electrical contact with the first annular ribbon conductor 30a. On the other hand, as can be seen most clearly in FIG. 3, the second elongate ribbon conductor 38 extends from a circular PCB (printed circuit board) 40 mounted above the battery 18, through the second head mounting portion 28b to make sliding electrical contact with the second annular ribbon conductor 30b (see also FIG. 4). PCB 40 includes the charging circuit 20 noted above. The PCB 40 is provided with an electrical contact 42 on its underside for making electrical contact with one end of the battery 18. A metal disc 44 provided in the bottom end of the housing 12 provides an electrical contact with the other end of the battery 18. The first elongate ribbon conductor 36 is electrically connected at its bottom end to the disc 44.

In this embodiment the battery 18 is a rechargeable battery and the cylindrical portion 13 is provided with a female electrical connector 46 within its base for connecting the battery 18 to an external battery charger (not shown). The charging circuit 20 may also include a simple battery charging circuit for providing a regulated recharge current and/or voltage from the external battery charger to the battery 18. For this purpose a third elongate electrical ribbon conductor 48 is provided extending longitudinally within the housing 12, from the charging circuit 20 on PCB 40 to the female connector 46 in the base of the cylindrical portion 13 of the housing 12. The female. connector 46 may conveniently be connected to mains power to recharge the electronic device back-up charger 10, for example by way of a mobile phone charger, micro-USB connector or other suitable adapter.

Advantageously the electronic device back-up charger 10 is sufficiently small to be carried on a key-ring, and is typically no longer than a key. The battery 18 is typically a rechargeable AAA battery rated at 1.2 -1.5 Volt. However the battery may be of another suitable voltage as appropriate. Typically the housing 12 of the electronic device back-up charger is between about 2.5 cm and 10.0 cm in length. More typically the housing of the electronic device back-up charger is between about 4.0 cm and 7.0 cm in length. The housing 12 is preferably manufactured from injection moulded plastics material. An external carry ring 50 is provided at the base of the housing 12 so that it can be hung on a key-ring or lanyard for easy carrying.

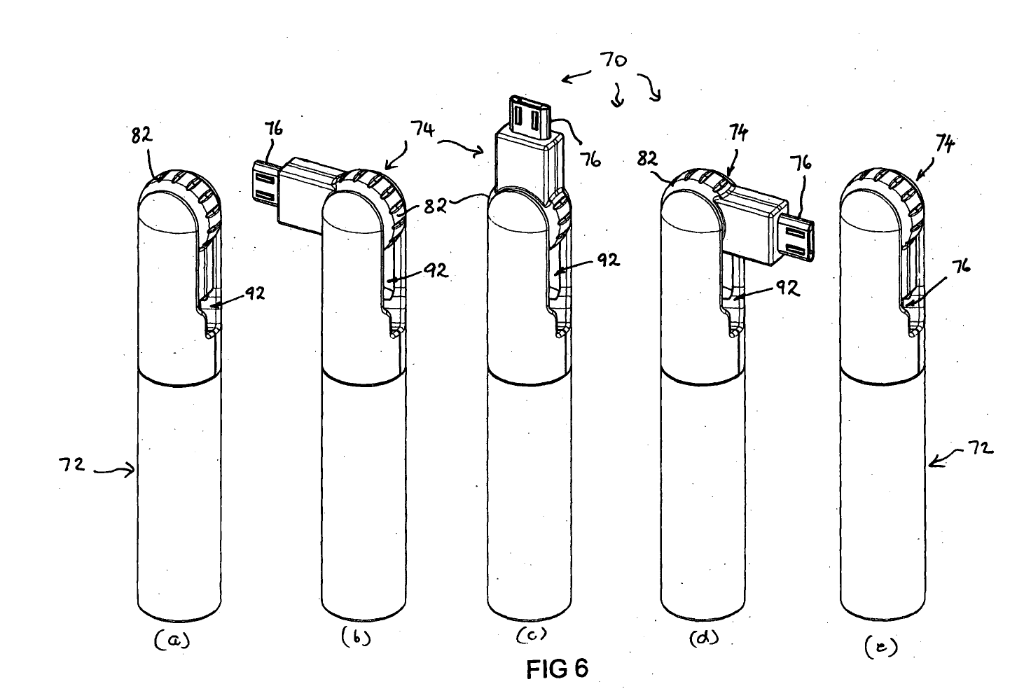

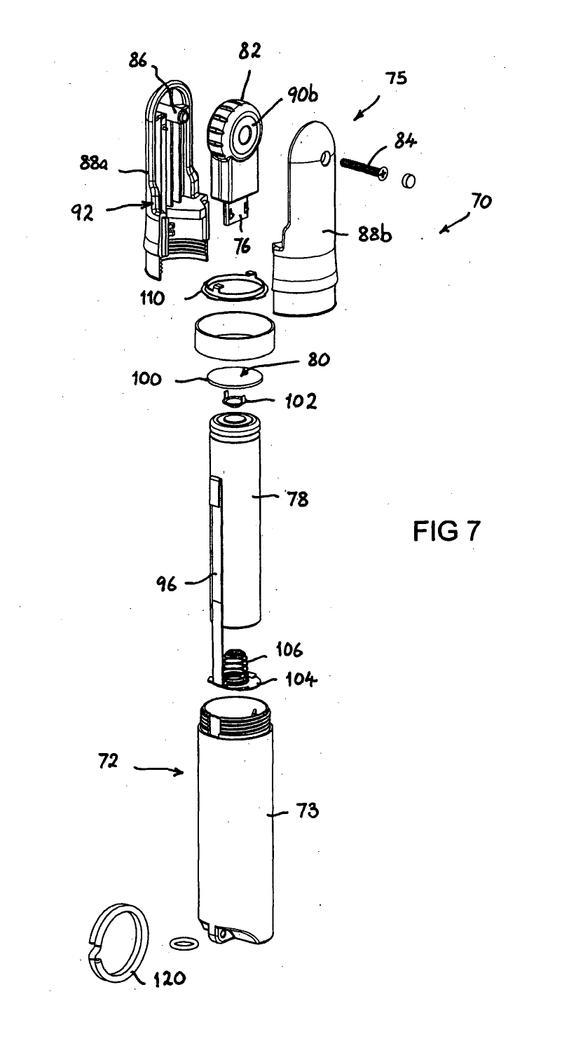

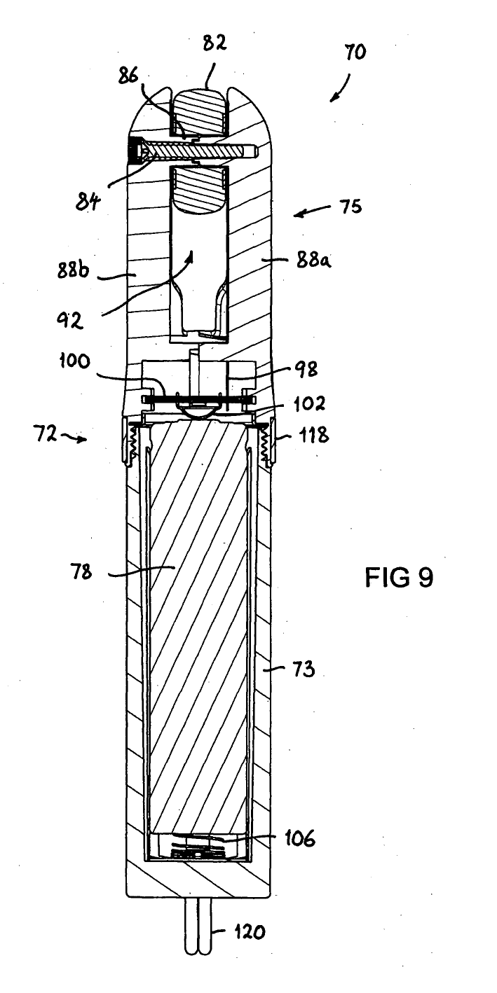

A second embodiment of the electronic device back-up charger 70 in accordance with the invention, as illustrated in FIGS. 6 to 13, comprises a housing 72 provided with a pivoting head portion 74. The head portion 74 has an electrical connector 76 mounted thereon for connecting the charger 70 to a mobile phone (not shown). As can be seen most clearly in FIGS. 7 and 9 (b); a battery 78 is provided inside the housing 72. The battery is electrically coupled to the connector 76. In use, the connector 76 can be pivoted to any desired angle, as shown in FIG. 6, and connected to a mobile phone for temporarily recharging the phone from the battery 78.

The battery 78 may be coupled to the connector 76 via a charging circuit 80. The charging circuit 80 may be a conventional battery charging circuit for providing a regulated, recharge current and/or voltage from the battery 78 to the mobile phone. Alternatively the charging circuit 80 may provide a direct electrical connection between the battery 78 and the connector 76 (and hence to the mobile phone). In most cases electronic devices are provided with their own internal charging circuitry and the battery charger is simply an adapter for converting the relatively high voltage AC power from the mains supply to low voltage DC power.

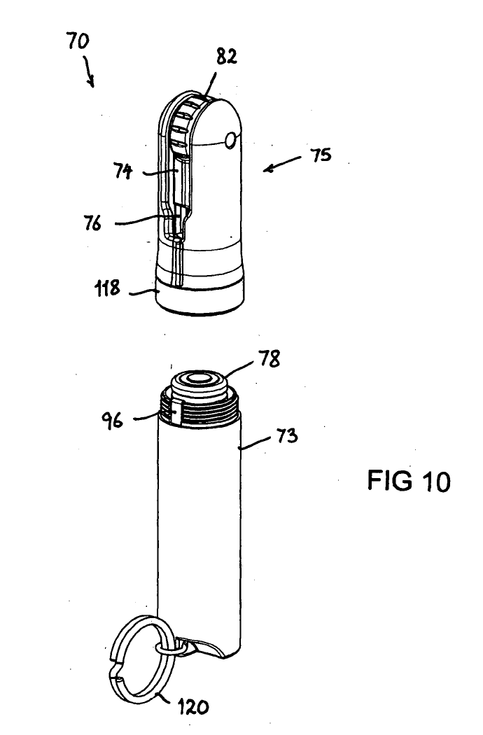

Preferably the housing 72 also includes an elongate cylindrical body 73 with a head 75 provided at the top end of the cylindrical body 73, on which the pivoting head portion 74 is mounted. Advantageously the head portion 74 can be pivoted so that the connector 76 is concealed within the head 75 of the housing 72, as shown in FIGS. 6(e) and 10. Preferably the head portion 74 comprises a pivot wheel 82 pivotally mounted on a pivot boss 86, and the electrical connector 76 is a male connector extending radially outwards from the pivot wheel 82.

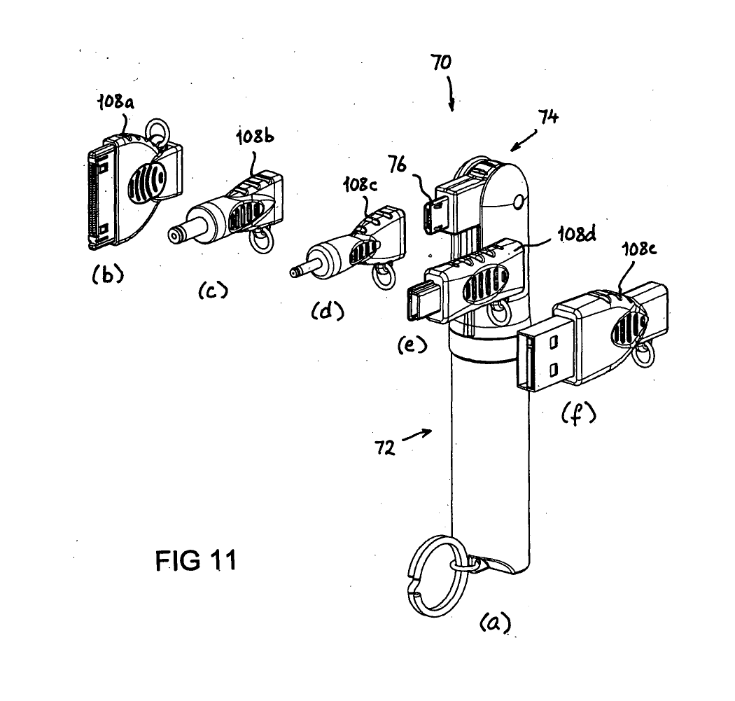

In this embodiment the electrical connector 76 is a standard Micro-USB connector, which has now been accepted as the universal standard by major mobile phone manufacturers. However various adapters 108 (see FIG. 11) may be supplied with the electronic device back-up charger 70, for connecting the connector 76 to different electronic device input jacks. Such adapters will become unnecessary when the universal standard becomes more widely adopted. FIG. 11 illustrates a variety of adapters 108a to 108e for connecting the connector 76 to various electronic device input jacks.

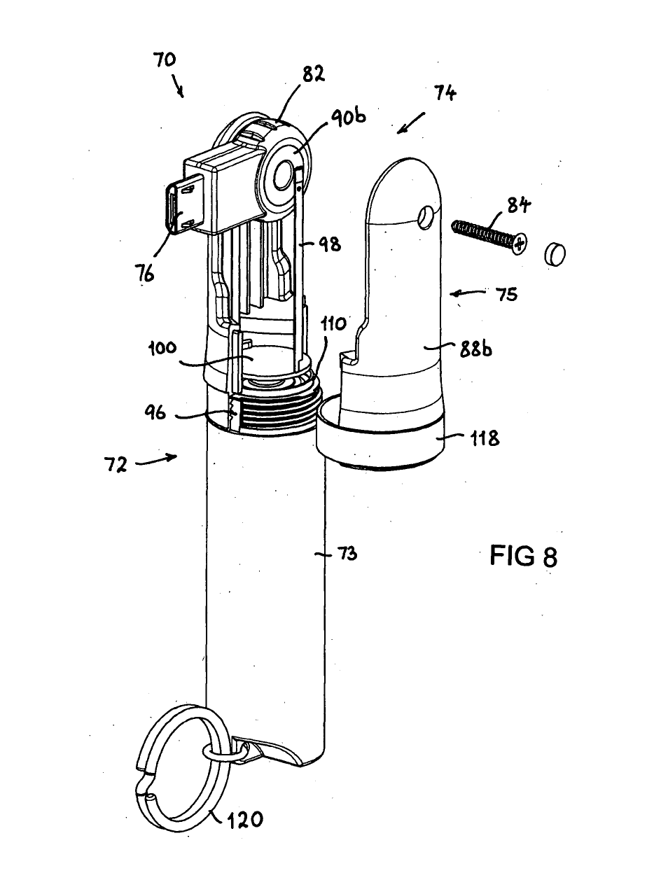

The pivot wheel 82 is pivotally mounted between first and second head mounting portions 88a and 88b of the housing 72. The wheel 82 and the first and second head mounting portions 88a and 88b of head 75 are held together by a screw 84, which passes through the pivot boss 86 for the wheel 82, and by an external ring clip 118. As can be seen most clearly in FIGS. 7 and 8, the head mounting portions 88 are moulded so as to form a recess 92 when they are joined together. Unlike the previous embodiment, the recess 92 extends from one side to the other of the head 75, and therefore the pivot wheel 82 can pivot 360°. Hence the recess 92 is adapted to receive the connector 76 therein when the pivot wheel 82 is pivoted to its concealed position in either direction.

To enable the connector 76 to be pivoted to any desired angle, the pivot wheel 82 is provided with a flexible electrical coupling between the connector 76 and the battery 78. For this purpose the pivot wheel 82 is provided with first and second annular electrical ribbon conductors 90a and 90b on its respective side faces. As can be seen in FIG. 9 (b), the respective terminals of the connector 76 are electrically connected to the respective ribbon conductors 90a and 90b by respective internal conductors 94a and 94b (not visible). First and second elongate electrical ribbon conductors 96 and 98 are provided within the elongate housing 72 for electrically coupling the battery 78 to the first and second annular ribbon conductors 90a and 90b respectively on the pivot wheel 82.

As can be seen most clearly in FIGS. 7 and 8, the first elongate ribbon conductor 96 extends from the bottom end of the cylindrical body 73 up to an annular electrical contact 110 mounted adjacent the underside of a circular PCB (printed circuit board) 100 and above the battery 78. On the other hand, as can be seen most clearly in FIG. 8, the second elongate ribbon conductor 98 extends from the PCB 100, through the second head mounting portion 88b to make sliding electrical contact with the second annular ribbon conductor 90b (see also FIG. 9). PCB 100 may include the charging circuit 80 noted above. The PCB 100 is also provided with an electrical contact 102 on its underside for making electrical contact with one end of the battery 78. A metal disc 104 provided in the bottom end of the housing 72 provides an electrical contact via a spring 106 with the other end of the battery 78. The first elongate ribbon conductor 96 is electrically connected at its bottom end to the disc 104.

In its assembled condition, as shown in FIGS. 9 and 10, the head 75 is held together by screw 84 and ring clip 118. The head 75 is attached to the cylindrical body 73 of the housing 72 by a screw-threaded attachment. For this purpose the bottom end of the head 75 is provided with an internal thread, which matches an external thread provided on the top end of the cylindrical body 73 of the housing. Ring clip 118 is provided at the bottom end of the head 75, on an external surface in the region of the internal thread, and helps to maintain the screw-threaded connection. In this embodiment the battery 78 is a non-rechargeable AAA battery. If it is desired to replace the battery 78, the head 75 can be readily unscrewed and separated from the rest of the housing 72, as shown in FIG. 10.

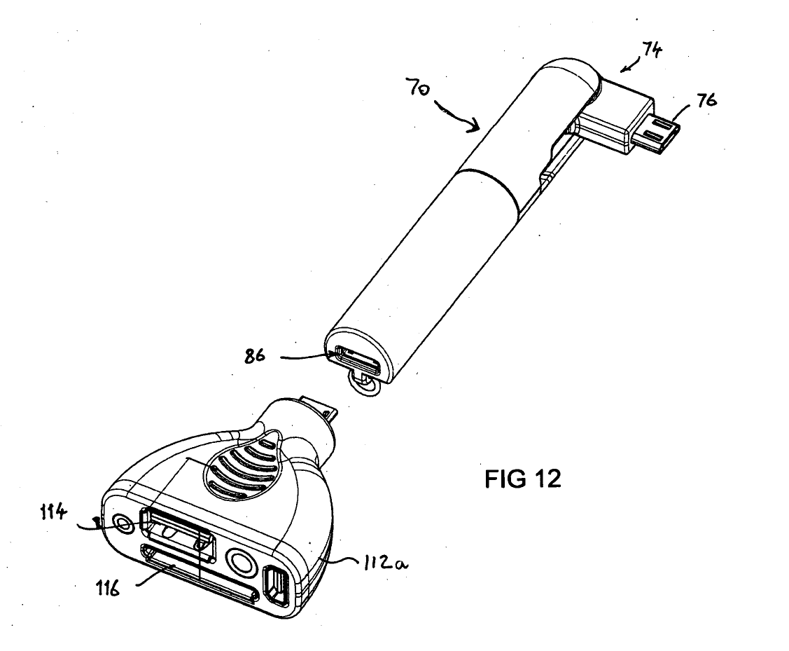

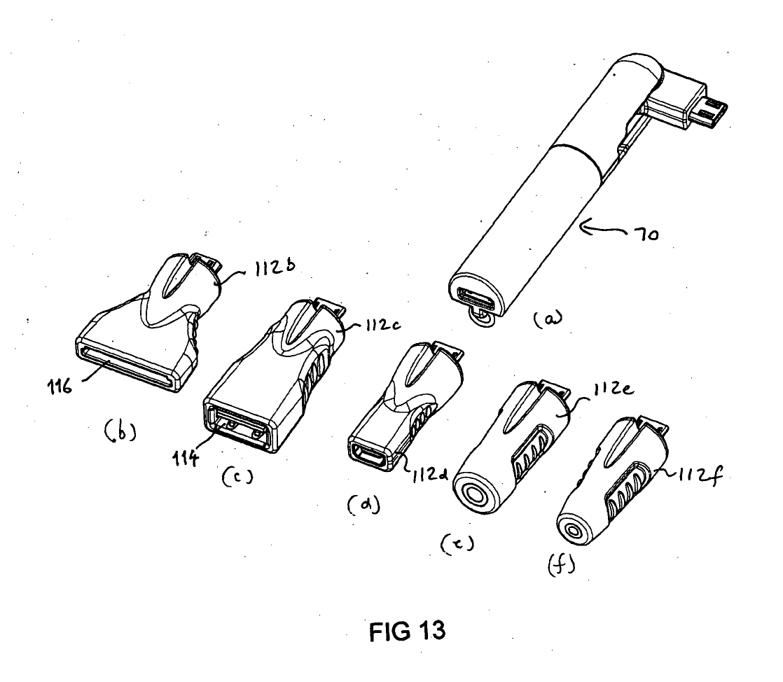

FIG. 12 illustrates a multi-head adapter 112a which can be plugged into a female connector 86 at the bottom end of the charger 70 to facilitate connection of the charger to a variety of electronic device chargers supplied by electronic device manufacturers. The multi-head adapter 112a includes a female standard USB connector 114, as well as a female iPhone connector 116. Advantageously the multi-head adapter 112a can also be used in a standard docking station (charger) for a mobile phone. Various single-head adapters 112b to 112f may also be supplied, as shown in FIG. 13, for connecting the charger 70 to a variety of electronic device chargers supplied by electronic device manufacturers.

The size and typical dimensions of the electronic device back-up charger 70 are similar to that of the first embodiment 10. An external carry ring 120 is provided at the base of the housing 72 so that it can be carried on a key-ring or lanyard.

Now that preferred embodiments of the electronic device back-up charger have been described in detail, it will be apparent that the described embodiments provide a number of advantages over the prior art, including the following:
(i) They are small and compact in design and therefore can be easily carried at all times with the electronic device for emergency use.
(ii) They may be rechargeable and therefore can be used multiple times and/or the non-rechargeable battery can be readily replaced with a new battery.
(iii) The pivoting head. design permits the back-up charger to be connected to the electronic device and held in one hand together with the phone while using the phone.
(iv) The pivoting head design permits the electrical connector to be concealed when not in use so that the charge is not inadvertently lost due to contact with a conducting object.
(v) The electronic device back-up charger can be easily recharged using mains power.

It will be readily apparent to persons skilled in the relevant arts that various modifications and improvements may be made to the foregoing embodiments, in addition to those already described, without departing from the basic inventive concepts of the present invention. For example, the housing is of cylindrical design to accommodate the battery; however the housing may be moulded in any desired shape. Therefore, it will be appreciated that the scope of the invention is not limited to the specific embodiments described and is to be determined from the appended claims.

1. An electronic device back-up charger comprising:
a housing provided with a pivoting head portion having an electrical connector mounted thereon for connecting the charger directly to an electronic device, the head portion comprising a pivot wheel, the pivot wheel having a grip surface provided on a periphery thereof to facilitate movement of the pivot wheel with a finger or thumb; and,
a battery provided inside the housing, the battery being electrically coupled to the connector wherein, in use, the connector can be pivoted to the desired angle and connected to an electronic device for temporarily recharging the device from the battery.

2. An electronic device back-up charger as defined in claim 1, wherein the head portion can be pivoted so that the connector is concealed within the housing.

3. An electronic device back-up charger as defined in claim 1, wherein the housing includes an elongate cylindrical portion with the head portion provided at the top end of the cylindrical portion.

4. An electronic device back-up charger as defined in claim 1, wherein the pivot wheel is pivotally mounted on a pivot boss, and the electrical connector is a male connector extending radially outwards from the pivot wheel.

5. An electronic device back-up charger as defined in claim 1, wherein the electrical connector is a micro-USB connector.

6. An electronic device back-up charger as defined in claim 1, wherein the electrical connector is a commercial phone charger connector.

7. An electronic device back-up charger as defined in claim 4, wherein the pivot wheel is pivotally mounted between first and second head mounting portions of the housing.

8. An electronic device back-up charger as defined in claim 7, wherein the pivot wheel is provided with a flexible electrical coupling between the connector and the battery.

9. An electronic device back-up charger as defined in claim 8, wherein the pivot wheel is provided with first and second annular electrical ribbon conductors on its respective side faces.

10. An electronic device back-up charger as defined in claim 9, wherein first and second elongate electrical ribbon conductors are provided within the housing for electrically coupling the battery to the first and second annular ribbon conductors respectively on the pivot wheel.

11. An electronic device back-up charger as defined in claim 10, wherein the first elongate ribbon conductor extends up through the first head mounting portion to make sliding electrical contact with the first annular ribbon conductor.

12. An electronic device back-up charger as defined in claim 1, wherein the battery is a rechargeable battery and the housing is provided with a female electrical connector for connecting the battery to an external charger.

13. An electronic device back-up charger as defined in claim 12, wherein the female connector may be used to recharge the battery using mains power.

14. An electronic device back-up charger as defined in claim 1, wherein the electronic device back-up charger is sufficiently small to be carried on a key-ring.

15. An electronic device back-up charger as defined in claim 14, wherein an external carry ring is provided at the base of the housing so that it can be carried on a key-ring or lanyard.

16. An electronic device back-up charger as defined in claim 14 or claim 15, wherein the housing of the electronic device back-up charger is between about 2.5 cm and 10.0 cm in length.

17. An electronic device back-up charger as defined in claim 16, wherein the housing of the electronic device back-up charger is between about 4.0 cm and 7.0 cm in length.

18. A mobile phone back-up charger comprising:
a housing provided with a pivoting head portion having an electrical connector mounted thereon for connecting the charger directly to a mobile phone, the head portion comprising a pivot wheel, the pivot wheel having a grip surface provided on a periphery thereof to facilitate movement of the pivot wheel with a finger or thumb; and, a battery provided inside the housing, the battery being electrically coupled to the connector wherein, in use, the connector can be pivoted to the desired angle and connected to a mobile phone for temporarily recharging the phone from the battery.

19. A mobile phone back-up charger as defined in claim 18, wherein the head portion can be pivoted so that the connector is concealed within the housing.

20. A mobile phone back-up charger as defined in claim 18, wherein the housing includes an elongate cylindrical portion with the head portion provided at the top end of the cylindrical portion.

21. A mobile phone back-up charger as defined in claim 18, wherein the pivot wheel is pivotally mounted on a pivot boss, and the electrical connector is a male connector extending radially outwards from the pivot wheel.

22. A mobile phone back-up charger as defined in claim 18, wherein the electrical connector is a micro-USB connector.

23. A mobile phone back-up charger as defined in claim 18, wherein the electrical connector is a commercial phone charger connector.

24. A mobile phone back-up charger as defined in claim 18, wherein the pivot wheel is pivotally mounted between first and second head mounting portions of the housing.

25. A mobile phone back-up charger as defined in claim 18, wherein the pivot wheel is provided with a flexible electrical coupling between the connector and the battery.

26. A mobile phone back-up charger as defined in claim 25, wherein the pivot wheel is provided with first and second annular electrical ribbon conductors on its respective side faces.

27. A mobile phone back-up charger as defined in claim 26, wherein first and second elongate electrical ribbon conductors are provided within the housing for electrically coupling the battery to the first and second annular ribbon conductors respectively on the pivot wheel.

28. (canceled)
